(19) United States
(12) Patent Application Publication
(10) Pub. No.: US 2013/0190443 A1
(43) Pub. Date: Jul. 25, 2013

(54) Thermoplastic moulding compositions with increased hydrolysis resistance

(71) Applicants: Günter Margraf, Dormagen (DE); Detlev Joachimi, Krefeld (DE)

(72) Inventors: Günter Margraf, Dormagen (DE); Detlev Joachimi, Krefeld (DE)

(73) Assignee: LANXESS DEUTSCHLAND GMBH, Leverkusen (DE)

(21) Appl. No.: 13/590,426

(22) Filed: Aug. 21, 2012

(30) Foreign Application Priority Data
Aug. 25, 2011 (EP) 11178821.2

(51) Int. Cl. C08L 77/06

(52) U.S. Cl. CPC C08L 77/06
USPC 524/514

(57) ABSTRACT

This invention relates to thermoplastic moulding compositions comprising A) polyamide and/or copolyamide, B) at least one copolymer of at least one olefin and of at least one acrylate of an aliphatic alcohol, C) at least one filler and/or reinforcing material, D) at least one oligomeric and/or polymeric carbodiimide, and optionally also at least one other additive E) and optionally at least one impact modifier F). The invention further relates to mouldings or semifinished products which are produced from the moulding compositions according to the invention, preferably by means of injection moulding. However, the present invention also relates to the use of a substance combination made of at least one component B) and of at least one component D) for improving the hydrolysis resistance of polyamide-based products.

### FIELD OF THE INVENTION

The invention relates to thermoplastic moulding compositions comprising A) polyamide and/or copolyamide, B) at least one copolymer of at least one olefin and of at least one acrylate of an aliphatic alcohol, C) at least one filler and/or reinforcing material, D) at least one oligomeric and/or polymeric carbodiimide, and optionally also at least one other additive E) and optionally at least one impact modifier F). The invention further relates to mouldings or semifinished products which are produced from the moulding compositions according to the invention, preferably by means of injection moulding. However, the present invention also relates to the use of a substance combination made of at least one component B) and of at least one component D) for improving the hydrolysis resistance of polyamide-based products.

### BACKGROUND OF THE INVENTION

Compounded materials made of glass-fibre-reinforced PA 66 (of nylon-6,6) have become established in automobile construction inter alia for producing components for the cooling circuits of motor vehicles. For the purposes of the present invention components for the cooling circuits of motor vehicles are inter alia cooling-water-distribution systems, cooling-water tanks, cooling-water expansion containers, thermostat housings, cooling-water pipes, heat-exchanger housings and cooling-system connectors.

In the motor-vehicle sector, coolant used in the cooling circuit comprises a mixture of ethylene glycol and water, preferably in a ratio of 1:1. In addition to this, small amounts of stabilizers are usually also used, especially in what are known as “longlife coolants”. The mixture of ethylene glycol and water begins to boil at 108° C. under atmospheric pressure; the water is first removed by distillation here, and as a consequence of this the proportion of ethylene glycol gradually increases. PA 66 begins to dissolve in ethylene glycol at 160° C. However, even conventional 1:1 mixtures of ethylene glycol and water attack glass-fibre-reinforced polyamides as soon as temperatures are above 100° C. The water/ethylene glycol mixture softens the plastic and moreover actively degrades the polymer matrix. This is a result of chemical reactions involving the ethylene glycol and the water which have an adverse effect not only on the polyamide itself but also on the coupling between the glass fibres and the polymer matrix. This process known as hydrolysis/glycolysis is comparatively slow at low temperatures, but is accelerated by higher temperatures.

The resistance of polyamide moulding compositions to mixtures of water and ethylene glycol is known as hydrolysis/glycolysis resistance and is often determined by using standard test specimens which are stored in the water/ethylene glycol mixture at from 120 to 135° C. in pressure-tight steel containers for 7, 21 and 42 days. After the storage procedure, mechanical tests are undertaken on the standard test specimens, preferably tensile tests, flexural tests, or impact-resistance determination, and the resultant properties are compared with those of standard test specimens freshly injection-moulded and not stored in the water/ethylene glycol mixture. The tests specimens are also investigated for cracking. The smaller the deterioration of the property under consideration between the condition fresh from injection moulding and the stored condition after 21 or 42 days, the higher the hydrolysis/glycolysis resistance of the polyamide moulding composition under consideration.

The hydrolysis/glycolysis resistance of components for the cooling circuits of motor vehicles is determined by subjecting the components to be investigated to storage in, or flow of, pure ethylene glycol at 120-135° C. or in water/ethylene glycol mixture at from 120-135° C. Once the storage procedure has concluded, bursting pressures are determined for the components and optical investigations are carried out in relation to cracking. The smaller the deterioration of the bursting pressure between the condition fresh from injection moulding and the stored condition, the higher the hydrolysis/glycolysis resistance of the component under consideration.

The increase in power ratings of the power trains of vehicles, with resultant higher engine temperatures and also therefore higher cooling-system temperatures, increases the stress placed on cooling-water-conducting components and leads to more stringent requirements in respect of the production of polyamide moulding compositions to be used. Some of these markedly more stringent requirements cannot be satisfied by semi-crystalline, aliphatic polyamides.

In this case, it is possible to use semi-crystalline, semi-aromatic polyphthalamides, which fill the properties gap between engineering thermoplastics and high-performance plastics. They feature lower and slower moisture absorption, better chemicals resistance and higher long-term service temperatures in comparison with semi-crystalline, aliphatic polyamides such as nylon-6 and nylon-6,6 (Hellerich, Harsch, Haenle, “Werkstoff-Führer Kunststoffe” [“Guide to Plastics Materials”], Carl Hanser Verlag, Munich, Vienna, 2004, 9th edition, pp. 159 to 161).

Disadvantages with the use of semi-crystalline, semi-aromatic polyphthalamides are higher price, higher density and markedly higher melt viscosity in comparison with nylon-6 and nylon-6,6. Furthermore, the significantly increased melting point leads to less cost-effective processing by injection moulding (Kunststoff-Handbuch 3/4, Polyamide [Plastics Handbook 3/4, Polyamides] Carl Hanser Verlag, Munich 1998, pp. 803-809).

DE 202010002421U1 describes injection-moulded or extruded components in the cooling circuit of a motor vehicle with improved resistance to hydrolysis and/or glycolysis, based on a substance mixture comprising polyamide and/or copolyamide, glass fibres with circular cross-sectional area and a filament diameter of from 6 to 11 μm or glass fibres with flat shape and non-circular cross-sectional area, where the width of the major cross-sectional axis of these is in the range from 6 to 40 μm and the width of the minor cross-sectional axis of these is in the range from 3 to 20 μm, and oligomeric or polymeric carbodiimide.

EP 0 567 884 A1 describes non-glass-fibre-reinforced polyamides stabilized with respect to hydrolysis at high temperatures, particularly in an acidic environment, which comprise from 0.1 to 5% of a polymeric aromatic carbodiimide based on the polyamide.

Copolymers of olefins with methacrylates or with acrylates can act as flow improvers in polyamide moulding compositions in the injection-moulding process. WO2005/121249 A1 says that, in the injection-moulding process, mixtures of at least one semi-crystalline thermoplastic polyamide with copolymers of olefins with methacrylates or acrylates of aliphatic alcohols of which the MFI is not less than 100 g/10 min reduce the melt viscosity of the resultant moulding compositions according to the invention (MR=Melt Flow Index). The MFI serves to characterize the flow of a melt of a thermoplastic and is subject to the standards ISO 1133 and ASTM D1238. The MFI (Melt Flow Index) and all of the data relating to the MFI in the context of the present invention relate to and respectively were measured or determined in all cases according to ISO 1133 at 190° C., with a test weight of 2.16 kg.

The object of the present invention consisted in providing substance mixtures or, respectively, thermoplastic moulding compositions based on polyamide, where these exhibit reduced moisture absorption and reduced fluid absorption, lower density, high resistance to chemicals, in particular to mixtures of water and ethylene glycol, at elevated temperature, in particular at temperatures of 130° C. and higher, and moreover permit cost-effective processing.

### DETAILED DESCRIPTION OF THE INVENTION

The object is achieved by, and the present invention therefore provides, thermoplastic moulding compositions comprising
A) from 25 to 79.85 parts by weight of one or more polyamides or copolyamides,
B) from 0.05 to 10 parts by weight, preferably from 1 to 6 parts by weight, particularly preferably from 1.5 to 5 parts by weight, of at least one copolymer of at least one olefin and of at least one acrylate of an aliphatic alcohol, where the MFI of the copolymer is greater than 10 g/10 min and this is measured or determined in accordance with ISO 1133 at 190° C. with a test weight of 2.16 kg,
C) from 10 to 65 parts by weight, preferably from 15 to 50 parts by weight, particularly preferably from 20 to 35 parts by weight of at least one filler and reinforcing material, and
D) from 0.05 to 10 parts by weight, preferably from 0.5 to 5 parts by weight, particularly preferably from 1 to 3 parts by weight of at least one oligomeric or polymeric carbodiimide, where the total of the parts by weight is 100.

Surprisingly, when components which are produced from the substance mixture according to the invention are compared with the prior art, they exhibit markedly improved hydrolysis resistance and also glycolysis resistance, preferably when they involve components in the cooling circuit of a motor vehicle and in particular when the components have exposure, at temperatures above 120° C., to a fluid comprising water and/or comprising glycol.

In one preferred embodiment, the thermoplastic moulding compositions according to the invention can also optionally comprise from 0.05 to 5 parts by weight of at least one other additive E) in addition to components A) to D), where the total of all the parts by weight is always 100, in that the parts by weight of components A) to D) are reduced correspondingly.

In one preferred embodiment, the thermoplastic moulding compositions according to the invention can also comprise F) from 0.05 to 5 part(s) by weight of at least one impact modifier in addition to components A) to E) or instead of E), where the total of all the parts by weight is always 100, in that the parts by weight of components A) to E) or A) to D) are reduced correspondingly.

However, the invention also provides the use of the said thermoplastic moulding compositions according to the invention comprising

A) from 25 to 79.85 parts by weight of one or more polyamides or copolyamides,

B) from 0.05 to 10 parts by weight, preferably from 1 to 6 parts by weight, particularly preferably from 1.5 to 5 parts by weight, of at least one copolymer of at least one olefin and of at least one acrylate of an aliphatic alcohol, where the MFI of the copolymer is greater than 10 g/10 min and this is measured or determined in accordance with ISO 1133 at 190° C. with a test weight of 2.16 kg,

C) from 10 to 65 parts by weight, preferably from 15 to 50 parts by weight, particularly preferably from 20 to 35 parts by weight of at least one filler and reinforcing material, and

D) from 0.05 to 10 parts by weight, preferably from 0.5 to 5 parts by weight, particularly preferably from 1 to 3 parts by weight of at least one oligomeric or polymeric carbodiimide,

where the total of the parts by weight is 100, for producing polyamide-based components, preferably polyamide-based components for cooling circuits, particularly preferably polyamide-based components in the cooling circuit of a motor vehicle, with particular preference cooling-water-distribution systems, cooling-water tanks, coolant-expansion containers, thermostat housings, cooling-water pipes, heat-exchanger housings or cooling-system connectors.

The present invention further provides a method for inhibiting hydrolysis and/or glycolysis of components in the coolant circuit of a motor vehicle, characterized in that the polyamides to be used for producing the said components take the form of a thermoplastic moulding composition according to the invention.

The present invention further provides the use of a substance combination made of at least one copolymer of at least one olefin and of at least one acrylate of an aliphatic alcohol and of at least one oligomeric or polymeric carbodiimide, in which the MFI of the copolymer is greater than 10 g/10 min, preferably greater than 150 g/10 min and particularly preferably greater than 300 g/10 min, where the MFI is measured or determined in accordance with ISO 1133 at 190° C. with a test weight of 2.16 kg and oligomeric or polymeric carbodiimide used comprises aliphatic, alicyclic or aromatic carbodiimides represented by the formula (II)

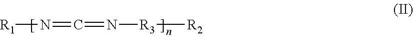

in which
R₁ and R₂ respectively mutually independently are a functional chemical group
R₃ symbolizes an aliphatic, alicyclic or aromatic group and
n means an integer from 3 to 1000,
in polyamide-based thermoplastic moulding compositions, preferably for improving the hydrolysis resistance of polyamide-based products, particularly preferably of polyamide-based components in cooling circuits, with particular preference in polyamide-based components in the cooling circuit of a motor vehicle.

There are many known types of process for producing the polyamides to be used as component A) in the thermoplastic moulding compositions according to the invention, and as a function of the desired final product use is made here of various monomer units, various chain regulators for setting a desired molecular weight, or else monomers having reactive groups for post-treatments intended at a later stage.

The industrially relevant processes for producing the polyamides to be used as component A) preferably proceed by way of polycondensation in the melt. According to the invention, polycondensation also covers the hydrolytic polymerization of lactams.

Polyamides preferred according to the invention are semi-crystalline or amorphous polyamides, where these can be produced starting from diamines and dicarboxylic acids and/or lactams having at least 5 ring members or from corresponding amino acids. Preferred starting materials used are aliphatic and/or aromatic dicarboxylic acids, particularly adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, pen tamethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, in particular aminocaproic acid, or the corresponding lactams. Copolyamides of a plurality of the monomers mentioned are included.

Particular preference is given to nylon-6 or nylon-6,6, and it is particularly preferable to use nylon-6,6 as component A) in the substance mixtures according to the invention.

It is moreover possible that proportions of recycled polyamide moulding compositions and/or of fibre recyclates are present.

The relative viscosity of the polyamides to be used as component A) is preferably from 2.3 to 4.0, particularly preferably from 2.7 to 3.5, where the relative viscosity can be determined or measured on a 1% by weight solution in m-cresol at 25° C.

The thermoplastic moulding compositions according to the invention comprise at least one copolymer B) of at least one olefin, preferably of an α-olefin and of at least one acrylate of an aliphatic alcohol, where the MFI of the copolymer B) is greater than 10 g/10 min, preferably greater than 150 g/10 min and particularly preferably greater than 300 g/10 min and this is measured or determined according to ISO 1133 at 190° C. with a test weight of 2.16 kg. In one preferred embodiment, the copolymer B) is composed of less than 4 parts by weight, particularly preferably less than 1.5 parts by weight and very particularly preferably 0 part by weight, of monomer units which comprise other reactive functional groups selected from the group consisting of epoxides, oxetanes, anhydrides, imides, aziridines, furans, acids, amines and oxazolines.

Preferred olefins as constituent of the copolymers B) are α-olefins and they particularly preferably have from 2 to 10 carbon atoms and can be unsubstituted or can have substitution by one or more aliphatic, cycloaliphatic or aromatic groups.

Very particularly preferred olefins are those selected from the group consisting of ethene, propene, 1-butene, 1-pentene, 1-hexene, 1-octene, 3-methyl-1-pentene. Olefins to which particular preference is given are ethene and propene, and in particular ethene is very particularly preferred.

Mixtures of the olefins described are likewise suitable.

In an embodiment to which further preference is given, the other reactive functional groups of the copolymer B) selected from the group consisting of epoxides, oxetanes, anhydrides, imides, aziridines, furans, acids, amines and oxazolines are introduced exclusively by way of the olefins into the copolymer B).

The content of the olefin in the copolymer B) is from 50 to 90 parts by weight, preferably from 55 to 75 parts by weight.

The copolymer B) is further defined via the second constituent alongside the olefin. Alkyl esters or arylalkyl esters of acrylic acid are used as second constituent, where the alkyl or arylalkyl group of these has from 1 to 30 carbon atoms. The alkyl or arylalkyl group here can be a linear or branched group and can also comprise cycloaliphatic or aromatic groups, and alongside this can also have substitution by one or more ether functions or thioether functions. Other suitable acrylates in this context are those synthesized from an alcohol component which is based on oligoethylene glycol or oligopropylene glycol having only one hydroxy group and at most 30 carbon atoms.

The alkyl group or arylalkyl group of the acrylic ester can preferably be one selected from the group consisting of methyl, ethyl, n-propyl, isopropyl, n-butyl, isobutyl, tert-butyl, sec-butyl, 1-pentyl, 1-hexyl, 2-hexyl, 3-hexyl, 1-heptyl, 3-heptyl, 1-octyl, 1-(2-ethyl)hexyl, 1-nonyl, 1-decyl, 1-dodecyl, 1-lauryl or 1-octadecyl. Preference is given to alkyl groups or arylalkyl groups having from 6 to 20 carbon atoms. In particular, preference is also given to branched alkyl groups, where these lead to a lower glass transition temperature T_{G} in comparison with linear alkyl groups having the same number of carbon atoms.

According to the invention, particular preference is given to copolymers B), in which the olefin is copolymerized with 2-ethylhexyl acrylate. Mixtures of the acrylates described are likewise suitable.

It is preferable here to use more than 60 parts by weight, particularly more than 90 parts by weight and very particularly 100 parts by weight, of 2-ethylhexyl acrylate, based on the total amount of acrylate in the copolymer B).

In an embodiment to which further preference is given, the other reactive functional groups selected from the group consisting of epoxides, oxetanes, anhydrides, imides, aziridines, furans, acids, amines and oxazolines of the copolymer B) are introduced exclusively by way of the acrylates into the copolymer B).

The content of the acrylates in the copolymer B) is from 10 to 50 parts by weight, preferably from 25 to 45 parts by weight.

The substance mixture to be used according to the invention comprises at least one filler and reinforcing material C).

The filler or reinforcing material used can therefore also comprise mixtures of two or more different fillers and/or reinforcing materials. Preference is given to use of fillers and/or reinforcing materials from the group of talc, mica, silicate, quartz, titanium dioxide, wollastonite, kaolin, amorphous silicas, magnesium carbonate, chalk, feldspar, barium sulphate, glass beads and/or fibrous fillers and/or reinforcing materials based on carbon fibres and/or glass fibres. It is particularly preferable to use mineral particulate fillers based on talc, mica, silicate, quartz, titanium dioxide, wollastonite, kaolin, amorphous silicas, magnesium carbonate, chalk, feldspar, barium sulphate and/or glass fibres.

It is very particularly preferable to use mineral particulate fillers based on talc, wollastonite, kaolin and/or glass fibres.

It is moreover also particularly preferable to use acicular mineral fillers. According to the invention, acicular mineral fillers are a mineral filler with pronounced acicular character. Acicular wollastonites may be mentioned as example. The said mineral preferably has a length:diameter ratio of from 2:1 to 35:1, particularly preferably from 3:1 to 19:1, with particular preference from 4:1 to 12:1. The average particle size of the acicular minerals according to the invention is preferably smaller than 20 μm, particularly preferably smaller than 15 μm, with particular preference smaller than 10 μm, determined by a CILAS GRANULOMETER.

As described above, the filler and/or reinforcing material in one preferred embodiment has been surface-modified, particularly preferably with a coupling agent or coupling-agent system, very particularly preferably with a coupling-agent system based on silane. However, the pre-treatment is not essential. In particular when glass fibres are used, it is also possible to use polymer dispersions, film formers, branching agents and/or glass-fibre-processing aids, in addition to silanes.

The glass fibres to be used with particular preference according to the invention can either have a circular cross-sectional area and a filament diameter of from 6 to 18 μm, preferably from 9 to 15 μm, or can have a flat shape and non-circular cross-sectional area, where the width of the major cross-sectional axis of this is in the range from 6 to 40 μm and the width of the minor cross-sectional axis of this is in the range from 3 to 20 μm. The glass fibre is preferably selected from the group of the E glass fibres, A glass fibres, C glass fibres, D glass fibres, S glass fibres and/or R glass fibres.

The form in which the glass fibres are added can be that of continuous-filament fibres or that of chopped or ground glass fibres. The fibres can have been equipped with a suitable size system, preferably comprising inter alia coupling agents in particular based on silane.

Silane-based coupling agents commonly used for the pre-treatment are silane compounds by way of example of the general formula (I)

(X—(CH₂)_{q})ₖ—Si—(O—CᵣH2ᵣ₊₁)₄₋ₖ (I)

in which the definitions of the substituents are as follows:

### X is NH₂—, HO— or

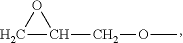

q is an integer from 2 to 10, preferably 3 to 4,
r is an integer from 1 to 5, preferably 1 to 2, and
k is an integer from 1 to 3, preferably 1.

Preferred coupling agents are silane compounds from the group of aminopropyltrimethoxysilane, aminobutyltrimethoxysilane, aminopropyltriethoxysilane, aminobutyltriethoxysilane and also the corresponding silanes of the formula (I), which comprise a glycidyl group as substituent X.

It is generally preferable that the amounts used of the silane compounds, based on the mineral filler, for the surface-coating process to modify the fillers are from 0.05 to 2% by weight, with preference from 0.25 to 1.5% by weight and in particular from 0.5 to 1% by weight.

As a result of the processing to give the moulding composition and, respectively, the moulding, the d97 value or d50 value of the particulate fillers in the moulding composition and in the moulding can be smaller than that of the fillers originally used. As a result of the processing to give the moulding composition and, respectively, the moulding, length distributions of the glass fibres in the moulding composition and in the moulding can be shorter than those originally used.

The thermoplastic moulding compositions according to the invention comprise at least one aliphatic, alicyclic or aromatic carbodiimide D), preferably a carbodiimide of the formula (II)

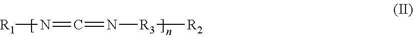

in which R₁ and R₂ respectively mutually independently are a functional chemical group, preferably respectively mutually independently an isocyanate moiety or a capped isocyanate moiety, R₃ symbolizes an aliphatic, alicyclic or aromatic group and n means an integer from 3 to 5000, preferably from 4 to 2000, particularly preferably from 5 to 1000.

Preferred suitable groups R₃ are divalent radicals of 2,6-diisopropylbenzene, naphthalene, 3,5-diethyltoluene, 4,4′-methylenebis(2,6-diethylenephenyl), 4,4′-methylenebis(2-ethyl-6-methylphenyl), 4,4′-methylenebis(2,6-diisopropylphenyl), 4,4′-methylenebis(2-ethyl-5-methylcyclohexyl), 2,4,6-triisopropylphenyl, n-hexane, cyclohexane, dicyclohexylmethane, methylcyclohexane and the like.

Preferred terminal groups R₁ and R₂ are isocyanates, which are characterized by a free NCO group, and capped isocyanates, the NCO groups of which have been subject to an addition reaction with reactive molecules such as secondary amines, oximes, lactams, esters or H-acidic compounds such as phenols, and the NCO groups of which can by way of example be liberated again by heating.

The oligomeric or polymeric carbodiimides to be used according to the invention are available commercially, examples being the Stabaxol P® products from Rhein Chemie GmbH.

In one preferred embodiment, the said thermoplastic moulding compositions according to the invention can also comprise at least one other conventional additive E) in addition to the components polyamide A), copolymer B), fillers and reinforcing materials C) and polycarbodiimide D), where the total of all of the percentages by weight is always 100, in that the parts by weight of components A) to D) are reduced correspondingly.

Preferred additives E) for the purposes of the present invention are stabilizers, antistatic agents, flow aids, mould-release agents, fire-protection additives, emulsifiers, nucleating agents, plasticizers, lubricants, dyes, pigments, branching agents, chain extenders or additives for increasing electrical conductivity values. The additives mentioned and other suitable additives are described by way of example in Gächter, Müller, Kunststoff-Additive [Plastics Additives], 3rd edition, Hanser-Verlag, Munich, Vienna, 1989 and in Plastics Additives Handbook, 5th edition, Hanser-Verlag, Munich, 2001. The additives can be used alone or in a mixture or in the form of masterbatches.

Preferred stabilizers are heat stabilizers and UV stabilizers. Stabilizers preferably used are copper(I) halides, preferably chlorides, bromides or iodides in conjunction with halides of alkali metals, preferably sodium halides, potassium halides and/or lithium halides, and other preferred stabilizers used are sterically hindered phenols, hydroquinones, phosphites, aromatic secondary amines such as diphenylamines, substituted resorcinols, salicylates, benzotriazoles or benzophenones, and also variously substituted representatives of the said groups or a mixture of these.

Preferred pigments or dyes used are titanium dioxide, ultramarine blue, iron oxide, carbon black, phthalocyanines, quinacridones, perylenes, nigrosin and anthraquinones.

Preferred nucleating agents used are sodium phenylphosphinate or calcium phenylphosphinate, aluminium oxide, silicon dioxide and also preferably talc powder.

Preferred lubricants and mould-release agents used are ester waxes, pentaerythritol tetrastearate (PETS), long-chain fatty acids, particularly preferably stearic acid or behenic acid and esters, salts of these, particularly preferably Ca stearate or Zn stearate, and also amide derivatives, preferably ethylenebisstearamide or montan waxes, preferably mixtures of straight-chain, saturated carboxylic acids having chain lengths of from 28 to 32 carbon atoms, and also low-molecular-weight polyethylene waxes or low-molecular-weight polypropylene waxes.

Preferred plasticizers used are dioctyl phthalate, dibenzyl phthalate, butyl benzyl phthalate, hydrocarbon oils and N-(n-butyl)benzenesulphonamide.

Preferred additives added for increasing electrical conductivity are conductive carbon blacks or other carbon blacks, carbon fibrils, nanoscale graphite fibres and nanoscale carbon fibres, graphite, conductive polymers, metal fibres and also other conventional additives for increasing electrical conductivity. Preferred nanoscale fibres used are those known as single-wall carbon nanotubes or multiwall carbon nanotubes (e.g. from Hyperion Catalysis).

In one particularly preferred embodiment, the present invention provides thermoplastic moulding compositions, and also components produced therefrom for cooling circuits, preferably for cooling circuits of motor vehicles, comprising
A) from 20 to 79.8 parts by weight of one or more polyamides or copolyamides,
B) from 0.05 to 10 parts by weight of at least one copolymer of at least one olefin and of at least one acrylate of an aliphatic alcohol, where the MFI of the copolymer is greater than 10 g/10 min and this is measured or determined in accordance with ISO 1133 at 190° C. with a test weight of 2.16 kg,
C) from 10 to 65 parts by weight of at least one filler and reinforcing material,
D) from 0.05 to 10 parts by weight of at least one oligomeric or polymeric carbodiimide, and
E) from 0.05 to 5 parts by weight of at least one other additive, where the additives used comprise nanoscale fibres, preferably single-wall carbon nanotubes or multiwall carbon nanotubes, and the total of all of the parts by weight is 100.

In another alternative preferred embodiment, the thermoplastic moulding compositions according to the invention can also optionally comprise F) from 0.001 to 80 parts by weight, particularly preferably from 1 to 10 parts by weight, of at least one elastomer modifier in addition to components A), B), C), D) and E) or instead of E), where the total of all of the parts by weight is always 100, in that the parts by weight of components A) to D) or A) to E) are reduced correspondingly. The elastomer modifiers to be used as component F) are also often termed impact modifiers, elastomer, modifier or rubber.

It is preferable that the elastomer modifiers involve copolymers where copolyamides are excluded, where these are preferably composed of at least two monomers from the group of ethylene, propylene, butadiene, isobutene, isoprene, chloroprene, vinyl acetate, styrene and acrylonitrile.

Polymers of this type are described by way of example in Houben-Weyl, “Methoden der organischen Chemie” [Methods of organic chemistry], Volume 14/1 (Georg-Thieme-Verlag, Stuttgart, 1961), pp. 392 to 406 and in the monograph “Toughened Plastics” by C. B. Bucknall (Applied Science Publishers, London, 1977).

Some elastomer modifiers to be used with preference according to the present invention are described below.

Preferred types of these elastomers to be used as impact modifiers are those known as ethylene-propylene rubbers (EPM) or ethylene-propylene-diene (EPDM) rubbers.

EPM rubbers generally have practically no residual double bonds, whereas EPDM rubbers can have from 1 to 20 double bonds per 100 carbon atoms.

Preferred diene monomers used for EPDM rubbers are conjugated dienes such as isoprene or butadiene, non-conjugated dienes having from 5 to 25 carbon atoms, e.g. penta-1,4-diene, hexa-1,4-diene, hexa-1,5-diene, 2,5-dimethylhexa-1,5-diene and octa-1,4-diene, cyclic dienes such as cyclopentadiene, cyclohexadiene, cyclooctadiene and dicyclopentadiene, and also alkenylnorbornenes, such as 5-ethylidene-2-norbornene, 5-butylidene-2-norbornene, 2-methallyl-5-norbornene, 2-isopropenyl-5-norbornene and tricyclodienes such as 3-methyltricyclo[5.2.1.0^{2,6}]-3,8-decadiene or a mixture of these. Particular preference is given to hexa-1,5-diene, 5-ethylidenenorbornene or dicyclopentadiene. The diene content of the EPDM rubbers is preferably from 0.5 to 50, in particular from 1 to 8% by weight, based on the total weight of the rubber.

Preferred EPM rubbers or EPDM rubbers have been grafted with reactive carboxylic acids or with derivatives of these. Maleic anhydride may be mentioned here with preference.

In one preferred embodiment, the rubbers also comprise dicarboxylic acids, preferably maleic acid or fumaric acid or derivatives of the said acids, preferably esters and anhydrides, and/or monomers comprising epoxy groups. These dicarboxylic acid derivatives or monomers comprising epoxy groups are preferably incorporated into the rubber via addition, to the monomer mixture, of monomers of the general formulae (III) or (IV) or (V) or (VI), where these comprise dicarboxylic acid groups and, respectively, epoxy groups,

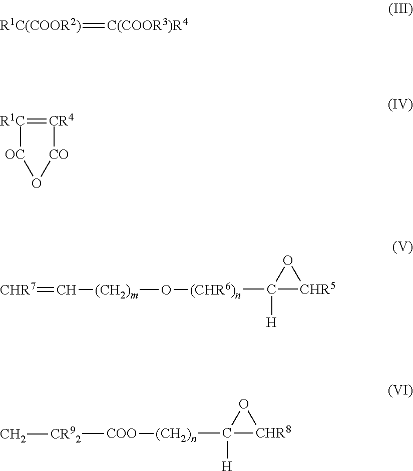

in which
R¹ to R⁹ are hydrogen or alkyl groups having from 1 to 6 carbon atoms,
m is an integer from 0 to 20, and
n is an integer from 0 to 10.

The moieties R¹ to R⁹ are preferably hydrogen, where m is 0 or 1 and n is 1. The corresponding compounds are maleic acid, fumaric acid, maleic anhydride, allyl glycidyl ether and vinyl glycidyl ether.

According to the invention, preferred compounds of the formulae (III), (IV) and (VI) are maleic acid, maleic anhydride and esters of methacrylic acid comprising epoxy groups, preferably glycidyl acrylate or glycidyl methacrylate and the methacrylic esters of tertiary alcohols, preferably tert-butyl methacrylate. Although the latter have no free carboxy groups, their behaviour approximates very closely to that of the free acids and for the purposes of the present invention they are therefore termed monomers having latent carboxy groups.

The copolymers to be used as elastomer modifiers of component F) are preferably composed of from 50 to 98 parts by weight of ethylene and 0.1 to 20 parts by weight of monomers comprising epoxy groups and/or monomers comprising anhydride groups.

It is preferable that vinyl esters or vinyl ethers are also used as comonomers. The ethylene copolymers described above can be produced by processes known per se, preferably via random copolymerization under high pressure and at elevated temperature. Corresponding processes are well known.

Other preferred elastomers are emulsion polymers, the production of which is described by way of example by Blackley in the monograph “Emulsion Polymerisation”. The catalysts and emulsifiers that can be used are known per se.

In principle, it is possible to use elastomers of homogeneous structure or else those having a shell structure. The shell-type structure is determined via the sequence of addition of the individual monomers; this sequence of addition also affects the morphology of the polymers.

Butadiene and isoprene, and also mixtures of these, may be mentioned here merely as representatives of monomers for producing the rubber portion of the elastomers. The said monomers can be copolymerized with other monomers, preferably styrene and acrylonitrile.

The soft phase or rubber phase (with a glass transition temperature below 0° C.) of the elastomers can be the core, the outer envelope or a middle shell (in the case of elastomers having a structure composed of more than two shells); in multishell elastomers it is also possible that a plurality of shells are composed of a rubber phase.

If the structure of the elastomer involves not only the rubber phase but also one or more hard components (with glass transition temperatures above 20° C.), these are generally produced via polymerization of styrene, acrylonitrile, methacrylonitrile, α-methylstyrene, or p-methylstyrene as main monomers. It is also possible here to use relatively small proportions of other comonomers, alongside these.

In some instances it has proved advantageous to use emulsion polymers which have reactive groups at the surface. Groups of this type are preferably epoxy, carboxy, latent carboxy, amino or amide groups, or else functional groups which can be introduced via concomitant use of monomers of the general formula (VII)

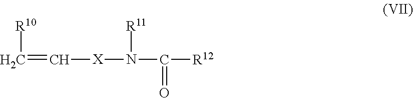

in which the definitions of the substituents can be as follows:
R¹⁰ hydrogen or a C₁-C₄-alkyl group,
R¹¹ hydrogen, a C₁-C₈-alkyl group or an aryl group, in particular phenyl,
R¹² hydrogen, a C₁-C₁₀-alkyl group, a C₆-C₁₂-aryl group or —OR¹³,
R¹³ a C₁-C₈-alkyl group or C₆-C₁₂-aryl group, which can optionally have substitution by O- or N-containing groups,
X a chemical bond, a C₁-C₁₀-alkylene group, a C₆-C₁₂-arylene group or

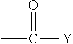

Y O—Z or NH—Z and
Z a C₁-C₁₀-alkylene group, or a C₆-C₁₂-arylene group.

The graft monomers described in EP 0 208 187 A2 are also suitable for introducing reactive groups at the surface.

Mention may moreover also be made of acrylamide and methacrylaimide.

In one preferred embodiment, the particles of the rubber phase have also been crosslinked. Preferred monomers used as crosslinking agents are buta-1,3-diene, divinylbenzene, diallyl phthalate and dihydrodicyclopentadienyl acrylate, and also the compounds described in EP 0 050 265 A1.

One preferred embodiment also uses what are known as graftlinking monomers, i.e. monomers having two or more polymerizable double bonds, where these react at different rates during the polymerization reaction. It is preferable to use compounds of this type in which at least one reactive group polymerizes at about the same rate as the other monomers, whereas the other reactive group(s) polymerize(s) by way of example markedly more slowly. The different polymerization rates give rise to a certain proportion of unsaturated double bonds in the rubber. If another phase is then grafted onto this type of rubber, at least some of the double bonds present in the rubber react with the graft monomers to form chemical bonds, i.e. there is at least some chemical bonding linking the grafted-on phase to the graft base.

Preferred graftlinking monomers are monomers comprising allyl groups, particularly preferably allyl esters of ethylenically unsaturated carboxylic acids, with particular preference diallyl maleate, diallyl fumarate, diallyl itaconate or the corresponding monoallyl compounds of the said dicarboxylic acids. Alongside these, there is a wide variety of other suitable graftlinking monomers; reference may be made here by way of example to U.S. Pat. No. 4,148,846 and US-A 4 327 201 for further details.

Some emulsion polymers preferred according to the invention are listed below. Mention may first be made here of graft polymers having a core and at least one outer shell and having the following structure:

TABLE 1

| Type | Monomers for the core | Monomers for the envelope |
|---|---|---|
| 1 | Buta-1,3-diene, isoprene, | Styrene, acrylonitrile |
| | styrene, acrylonitrile | |
| 2 | as 1, but with | as 1 |
| | concomitant use of | |
| | crosslinking agents | |
| 3 | as 1 or 2 | Buta-1,3-diene, isoprene |
| 4 | as 1 or 2 | as 1 or 2, but with concomitant use of |
| | | monomers having reactive groups as |
| | | described herein |
| 5 | Styrene, acrylonitrile, | first envelope made of monomers as |
| | methyl methacrylate | described in 1 and 2 for the core |
| | or a mixture of these | second envelope as described in 1 or 4 |
| | | for the envelope |

Instead of graft polymers having a multishell structure, it is also possible to use homogeneous, i.e. single-shell, elastomers made of buta-1,3-diene, of isoprene or of copolymers of these. Again, these products can be produced via concomitant use of crosslinking monomers or of monomers having reactive groups.

Examples of preferred emulsion polymers are graft polymers having an inner core of, or based on, butadiene and an outer envelope made of the abovementioned copolymers.

The elastomers described can also be produced by other conventional processes, preferably via suspension polymerization. Preference is likewise given to silicone rubbers as described in DE 3 725 576 A1, EP 0 235 690A2, DE 3 800 603 A1 and EP 0 319 290 A1.

It is also possible, of course, to use mixtures of the types of rubber listed above.

According to the invention, preference is given in particular to use of elastomer modifiers of the EPM or EPDM type as component F).

For clarification, it should be noted that the scope of the invention comprises all of the listed definitions and parameters mentioned in general terms or in preferred ranges, in any desired combination.

The present application also provides the use of the thermoplastic moulding compositions according to the invention in the injection-moulding process, inclusive of the following special processes: GIT (gas-injection technology), WIT (water-injection technology) and PIT (projectile-injection technology), in profile extrusion or other extrusion processes and in blow moulding, particularly preferably standard extrusion blow moulding, 3D extrusion blow moulding processes or suction blow moulding processes or for the production of components.

Processes according to the invention for producing components via extrusion or injection moulding operate at melt temperatures in the range from 230 to 330° C., preferably from 250 to 300° C. and also optionally at pressures of at most 2500 bar, preferably at pressures of at most 2000 bar, particularly preferably at pressures of at most 1500 bar and very particularly preferably at pressures of at most 750 bar.

A feature of the injection moulding process is that the raw material, preferably in granulate form, is melted (plastified) in a heated cylindrical cavity and is injected in the form of injection-moulding composition under pressure within a temperature-controlled cavity. The injection moulding is demoulded after cooling (solidification) of the melt.

The different phases are:

### 1. Plastification/melting

2. Injection phase (injection procedure)
3. Hold-pressure phase (for thermal contraction during crystallization)

### 4. Demoulding.

An injection-moulding machine is composed of a clamping unit, the injection unit, the drive and the control system. The clamping unit has fixed and movable platens for the mould, an end platen, and also tie bars and drive for the movable mould platen (toggle assembly or hydraulic clamping unit).

An injection unit encompasses the electrically heatable cylinder, the screw drive (motor, gearbox) and the hydraulic system for displacing the screw and injection unit. The function of the injection unit consists in melting, metering and injecting the powder or the pellets and applying hold pressure thereto (to allow for contraction). The problem of reverse flow of the melt within the screw (leakage flow) is solved via non-return valves.

Within the injection mould, the inflowing melt is then separated and cooled, and the required component is thus manufactured. Two mould halves are always needed for this process. The different functional complexes in the injection-moulding process are as follows:
runner system
shaping inserts
venting
system for retaining machine and withstanding forces
demoulding system and transmission of movement
temperature control.

The specialized injection-moulding processes GIT (gas-injection technology), WIT (water-injection technology) and PIT (projectile-injection technology) are intended for the production of hollow workpieces. A difference from standard injection moulding consists in a specific operation towards the end of the mould-filling phase or after defined partial filling of the injection mould. In the operation specific to the process, what is known as an injector is used to inject a process medium into the molten interior of the preform, in order to form a cavity. In the case of GIT, gas is involved here—generally nitrogen—and in the case of WIT, water is involved. In the case of PIT, a cavity is formed by propelling a projectile into the molten interior.

In contrast to injection moulding, in extrusion the extruder, which is a machine for producing shaped thermoplastics, produces a continuous plastics extrudate, in this case a polyamide. A distinction is made between

single-screw extruders and twin-screw extruders, and also the respective subgroups of
conventional single-screw extruders, conveying single-screw extruders,
contrarotating twin-screw extruders and corotating twin-screw extruders.

For the purposes of the present invention, profiles are components or parts which have identical cross section through their entire length. They can be produced by the profile extrusion process. The fundamental steps in the profile extrusion process are:
1. Plastification and provision of the thermoplastic melt in an extruder.
2. Extrusion of the thermoplastic melt extrudate through a calibrating envelope which has the cross section of the required profile.
3. Cooling of the extruded profile on a calibrating table.
4. Onward transport of the profile using a take-off behind the calibrating table.
5. Cutting the continuous profile to length in a cutter system.
6. Collecting the cut-to-length profiles on a collection table.

A description of profile extrusion of nylon-6 and nylon-6,6 is given in Kunststoff-Handbuch [Plastics handbook] 3/4, Polyamide [Polyamides], Carl Hanser Verlag, Munich 1998, pp. 374-384.

For the purposes of the present invention, blow moulding processes are preferably standard extrusion blow moulding, 3D extrusion blow moulding, suction blow moulding processes and sequential coextrusion.

According to Thielen, Hartwig, Gust, “Blasformen von Kunststoffhohlkorpern” [Blow moulding of plastics], Carl Hanser Verlag, Munich 2006, pp. 15 to 17, the fundamental steps of the standard extrusion blow moulding process are:
1. Plastification and provision of the thermoplastic melt in an extruder.
2. Deflection of the melt to flow vertically downward and shaping of a tubular melt “parison”.
3. Using a mould, the blow mould, generally composed of two half shells, to enclose the parison, freely suspended below the head.
4. Insertion of a blowing mandrel or of one (or more) blowing pin(s).
5. Blowing of the plastic parison onto the cooled wall of the blow mould, where the plastic cools and hardens, and assumes the final shape of the moulded part.
6. Opening of the mould and demoulding of the blow-moulded part.
7. Removal of the pinched-off “flash” waste at both ends of the blow-moulded part.

Other downstream operations can follow.

Standard extrusion blow moulding can also be used to produce components with complex geometry and multiaxial curvature. However, the resultant moulded parts then comprise a high proportion of excess, pinched-off material and have large regions with a pinch-off weld.

To avoid pinch-off welds and to reduce materials usage, 3D extrusion blow moulding, also termed 3D blow moulding, therefore uses specific devices to deform and manipulate a parison with diameter appropriately adapted to the cross section of the item, and then introduces this directly into the cavity of the blow mould. The extent of the remaining pinch-off edge is therefore reduced to a minimum at the ends of the item (Thielen, Hartwig, Gust, “Blasformen von Kunststoffhohlkörpern” [Blow moulding of plastics], Carl Hanser Verlag, Munich 2006, pp. 117-122).

In suction blow moulding processes, the parison is conveyed directly from the tubular die head into the closed blow mould and “sucked” through the blow mould by way of an air stream. Once the lower end of the parison emerges from the blow mould, clamping elements are used to pinch off the upper and lower ends of the parison, and the blowing and cooling procedure then follows (Thielen, Hartwig, Gust, “Blasformen von Kunststoffhohlkörpern” [Blow moulding of plastics], Carl Hanser Verlag, Munich 2006, p. 123).

The present invention therefore also provides moulded parts, mouldings or semifinished products obtainable via profile extrusion or other extrusion processes, blow moulding, particularly preferably standard extrusion blow moulding, 3D extrusion blow moulding processes, and suction blow moulding processes, and sequential coextrusion or injection moulding, of the thermoplastic moulding compositions according to the invention.

The present invention therefore also provides the use of the thermoplastic moulding compositions according to the invention in components, involving moulded parts, mouldings or semifinished products which are obtained by means of injection moulding, profile extrusion or other extrusion processes, or blow moulding, in particular by means of injection moulding.

However, the present invention also provides the use of the moulded parts, mouldings or semifinished products obtainable from the thermoplastic moulding compositions according to the invention in the motor vehicle industry, electrical industry, electronics industry, telecommunications industry, or computer industry, in sports, in medicine, in households, in the construction industry or in the entertainment industry.

However, the present invention also provides the use of the said moulded parts, mouldings or semifinished products as air-conducting components, cooling-water-conducting components, oil-conducting components, containers and pipes conducting other fluids, fuel tanks or oil tanks.

However, the present invention also provides the use of the said cooling-water-conducting components in a motor vehicle as cooling-water-distribution systems, cooling-water tanks, coolant-expansion containers, thermostat housings, cooling-water pipes, heat exchangers or cooling-system connectors.

It will be understood that the specification and examples are illustrative but not limitative of the present invention and that other embodiments within the spirit and scope of the invention will suggest themselves to those skilled in the art.

### EXAMPLES

In order to demonstrate the improvements described according to the invention, appropriate plastics moulding compositions were first prepared by compounding. The individual components were mixed at temperatures of from 280 to 320° C. in a twin-screw extruder (ZSK 26 Mega Compounder from Coperion Werner & Pfleiderer, Stuttgart, Germany), discharged in the form of extrudate into a water bath, cooled until pelletizable and pelletized.

Test specimens for the mechanical tests were produced from the moulding compositions in an injection-moulding machine. The tests carried out on the resultant test specimens were as follows: flexural test in accordance with ISO 178, and Izod impact test in accordance with ISO 180 1U.

In order to assess hydrolysis resistance, the change in Izod impact resistance in accordance with ISO 180 1U, in flexural strength and in outer fibre strain at maximum force were determined in each case at room temperature.

For this, the test specimens were stored for 42 days in a 1:1 (volume) ethylene glycol/water mixture in an autoclave at 130° C. After storage, the test specimens were rinsed with demineralized water and dried, and then tested in the flexural test in accordance with ISO 178 and, respectively, in the Izod impact test in accordance with ISO 180 1 U. In order to determine the initial values, the flexural test in accordance with ISO 178 and the Izod impact test in accordance with ISO 180 1U were carried out on test specimens fresh from the injection-moulding process, without storage.

Comparison 1 does not comprise copolymers B) or polymeric carbodiimides D). Comparison 2 comprises copolymers B) based on WO2005/121249 A1. Comparison 3 comprises polymeric carbodiimides based on EP 0 567 884 and DE 202010002421U1.

In comparison with Comparisons 1, 2 and 3, test specimens from Example 1 according to the invention exhibit a marked improvement in Izod impact resistance in accordance with ISO 180 1U, in flexural strength, and in outer fibre strain after storage for 42 days in a 1:1 (volume) mixture of ethylene glycol/water in an autoclave at 130° C.

TABLE 2
Examples
The table below states the amounts of the starting materials
in parts by weight and the effects according to the invention.

| | | Comparison 1 | Comparison 2 | Comparison 3 | Example 1 |
|---|---|---|---|---|---|
| Nylon-6,6 ¹⁾ | [%] | 67.6 | 66.1 | 61.6 | 64.1 |
| Glass fibre ²⁾ | [%] | 30 | 30 | 30 | 30 |
| Ethylene-acrylate copolymer ³⁾ | [%] | | | 6 | 2 |
| Polycarbodiimide ⁴⁾ | [%] | | 1.5 | | 1.5 |
| Additives ⁵⁾ | [%] | 2.4 | 2.4 | 2.4 | 2.4 |
| Injection-moulding melt | [° C.] | 290 | 290 | 290 | 290 |
| temperature | | | | | |
| Injection-moulding mould | [° C.] | 80 | 80 | 80 | 80 |
| temperature | | | | | |
| ISO 180 1U Izod impact | [kJ/m²] | 76 | 82 | 74 | 80 |
| resistance, fresh from | | | | | |
| injection moulding | | | | | |
| ISO 180 1U Izod impact | [kJ/m²] | 30 | 36 | 25 | 42 |
| resistance, after storage for | | | | | |
| 42 days | | | | | |
| Flexural strength, fresh from | [MPa] | 280 | 283 | 249 | 267 |
| injection moulding | | | | | |
| Flexural strength, | [MPa] | 45 | 60 | 48 | 67 |
| after storage for 42 days | | | | | |
| Outer fibre strain, fresh from | [%] | 4.3 | 4.5 | 4.2 | 4.6 |
| injection moulding | | | | | |
| Outer fibre strain, | [%] | 1.6 | 2.2 | 1.8 | 2.7 |
| after storage for 42 days | | | | | |

¹⁾ Linear nylon-6,6 with a relative viscosity of 3.0 at 25° C. in a 1% by weight solution in meta-cresol, from Radici, Italy
²⁾ CS 7997 EC10 glass fibre from Lanxess Deutschland GmbH
³⁾ Copolymer of ethene and 2-ethylhexyl acrylate having 63% by weight ethene content and an MFI of 550
⁴⁾ Stabaxol ® P100 from Rhein Chemie GmbH
⁵⁾ Other additives present are: copper iodide heat stabilizer (from 300 to 400 ppm) in a mixture with potassium bromide (from 800 to 1000 ppm), about 0.2% of mould-release aid (amide wax or montan ester wax), 0.2 to 0.8% of black (carbon black or nigrosin) and about 200 ppm of microtalc powder as nucleating agent. The additives can be used in the form of concentrates known as masterbatches, comprising polyamide.

What is claimed is:

1. A thermoplastic moulding composition comprising
A) from 25 to 79.85 parts by weight of one or more polyamides or copolyamides,
B) from 0.05 to 10 parts by weight of at least one copolymer of at least one olefin and of at least one acrylate of an aliphatic alcohol, where the MFI of the copolymer is greater than 10 g/10 min and this is measured or determined in accordance with ISO 1133 at 190° C. with a test weight of 2.16 kg,
C) from 10 to 65 parts by weight of at least one filler and reinforcing material, and
D) from 0.05 to 10 parts by weight of at least one oligomeric or polymeric carbodiimide,
where the total of the parts by weight is 100.

2. A thermoplastic moulding composition according to claim 1, wherein in addition to components A) to D),
E) from 0.05 to 5 parts by weight of at least one other additive
is/are also used, where the total of the parts by weight is always 100, in that the parts by weight of components A) to D) are reduced correspondingly.

3. A thermoplastic moulding composition according to claim 1 or 2, wherein in addition to components A) to E) or instead of E),
F) from 1 to 10 parts by weight of at least one elastomer modifier
is/are used, where the total of the parts by weight is always 100, in that the parts by weight of components A) to D) or A) to E) are reduced correspondingly.

4. A thermoplastic moulding composition according to any of claims 1 to 3, wherein oligomeric or polymeric carbodiimide used comprises aliphatic, alicyclic or aromatic carbodiimides represented by the formula (II) 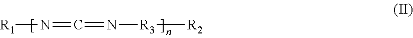
in which
R₁ and R₂ respectively mutually independently are a functional chemical group
R₃ symbolizes an aliphatic, alicyclic or aromatic group and
n means an integer from 3 to 1000.

5. A thermoplastic moulding composition according to one of claims 1 to 4, wherein stabilizers, antistatic agents, flow aids, mould-release agents, fire-protection additives, emulsifiers, nucleating agents, plasticizers, lubricants, dyes, pigments, branching agents, chain extenders or additives for increasing electrical conductivity are used as additives of component E).

6. A process for improving the hydrolysis resistance of polyamide-based products wherein a substance combination made of at least one copolymer of at least one olefin and of at least one acrylate of an aliphatic alcohol and of at least one oligomeric or polymeric carbodiimide, in which the MFI of the copolymer is greater than 10 g/10 min, where the MFI is measured or determined in accordance with ISO 1133 at 190° C. with a test weight of 2.16 kg and oligomeric or polymeric carbodiimide comprising aliphatic, alicyclic or aromatic carbodiimides represented by the formula (II) 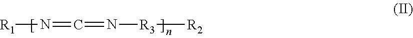
in which
R₁ and R₂ respectively mutually independently are a functional chemical group
R₃ symbolizes an aliphatic, alicyclic or aromatic group and
n means an integer from 3 to 1000,
is used in thermoplastic moulding compositions comprising
A) from 25 to 79.85 parts by weight of one or more polyamides or copolyamides,
B) from 0.05 to 10 parts by weight of at least one copolymer of at least one olefin and of at least one acrylate of an aliphatic alcohol, where the MFI of the copolymer is greater than 10 g/10 min and this is measured or determined in accordance with ISO 1133 at 190° C. with a test weight of 2.16 kg,
C) from 10 to 65 parts by weight of at least one filler and reinforcing material, and
D) from 0.05 to 10 parts by weight of at least one oligomeric or polymeric carbodiimide,
where the total of the parts by weight is 100 and moulded parts, mouldings or semifinished products are obtained by means of injection moulding, profile extrusion or other extrusion processes, or blow moulding.

7. A process according to claim 6 wherein the moulded parts, mouldings or semifinished products are used in the motor vehicle industry, electrical industry, electronics industry, telecommunications industry, or computer industry, in sports, in medicine, in households, in the construction industry or in the entertainment industry.

8. A process according to claim 7 wherein the moulded parts, mouldings or semifinished products are air-conducting components, cooling-water-conducting components, oil-conducting components, containers and pipes conducting other fluids, fuel tanks or oil tanks.

9. A process according to claim 8 wherein the cooling-water-conducting components in the cooling circuit of a motor vehicle are cooling-water-distribution systems, cooling-water tanks, coolant-expansion containers, thermostat housings, cooling-water pipes, heat exchangers or cooling-system connectors.

10. A process for inhibiting hydrolysis and/or glycolysis of components in the coolant circuit of a motor vehicle, wherein the polyamides to be used for producing the said components take the form of a thermoplastic moulding composition comprising
A) from 25 to 79.85 parts by weight of one or more polyamides or copolyamides,
B) from 0.05 to 10 parts by weight of at least one copolymer of at least one olefin and of at least one acrylate of an aliphatic alcohol, where the WI of the copolymer is greater than 10 g 110 min and this is measured or determined in accordance with ISO 1133 at 190° C. with a test weight of 2.16 kg,
C) from 10 to 65 parts by weight of at least one filler and reinforcing material, and
D) from 0.05 to 10 parts by weight of at least one oligomeric or polymeric carbodiimide,
where the total of the parts by weight is 100.

11. A process according to claim 10 wherein the production of the components uses processes of injection moulding, of extrusion or of suction blow moulding.

12. A process according to claim 11 wherein the processes of injection moulding or of extrusion operate at melt temperatures in the range from 230 to 330° C.
